(19) United States
(12) Patent Application Publication
(10) Pub. No.: US 2006/0239453 A1
(43) Pub. Date: Oct. 26, 2006

(54) Data encryption system for internet communication

(76) Inventor: John W. Halpern, Ingram Crescent (GB)

Correspondence Address: ALIX YALE & RISTAS LLP, 750 MAIN STREET, SUITE 1400, HARTFORD, CT, 06103, US

(21) Appl. No.: 11/452,002

(22) Filed: Jun. 13, 2006

Related U.S. Application Data
(63) Continuation of application No. 09/787,575, filed on Apr. 8, 2002, now abandoned.

(30) Foreign Application Priority Data
Sep. 25, 1997 (GB) 9720478.8
Sep. 24, 1998 (GB) 9820824.2

(51) Int. Cl. H04L 9/00

(52) U.S. Cl. 380/45

(57) ABSTRACT

Two versions of a variable word length encryption method are discussed. The methods are adapted for providing the means for long-term confidential transmission of printed characters, pictures, and voice dialogues over telephone lines or the Internet.

### CROSS REFERENCE TO RELATED APPLICATIONS

This application is a continuation of co-pending U.S. patent application Ser. No. 09/787,575, filed Apr. 8, 2002, which claims priority from GB 9720478.8 and GB 9820824.2, all of which are incorporated herein by reference.

### BACKGROUND OF THE INVENTION

There is a general consensus that serious use of the Internet potential for the needs of commerce and industry requires a 100% long-term effective system for protecting privacy of the interchanges.

Several aspects apart from privacy would be important in making a choice of the technique. It would have to be suitable for all digital transmissions, irrespective of the coding employed. The same encryption system should be workable for lettered, audible or visual messages. Also, the time of processing the data should preferably not add more than 80% to the time for transmitting the same data in the clear form. Furthermore, no time should be spent on looking up directories for keys or other procedure rules.

### SUMMARY OF THE INVENTION

The objectives of this patent application follow from what has just been said:
to create for owners of PC's certain supplementary components easily added with the result of replacing registered and high-priority mail transmissions by a less extensive and faster track protected against breach of confidentiality.
to reduce the need for personal trustworthiness and to replace it by trustworthiness of the provisions of the system.
While the idea of “trusted third parties” is appropriate where government interests are directly involved, the many contingencies that arise when applied to all communications would strain an already overburdened legal system.

In contradistinction, the here proposed method would save trustworthy server stations from slipping into arbitrariness, favoritism and self-serving bureaucracy. At the same time it would open a clear route for observers at government level to use their authority of sampling messages in the interest of crime prevention and to do so even for longer periods if and when properly authorized and reasoned for in exposes open for public inspection within six years.

This paper will outline the technical platform for accomplishing the above sketched objectives, with the further provision that its service be available to everyone at a relatively low extra cost over and above the cost of using Internet communication.

The said ‘technical platform’ constitutes a system resting on two main pillars, namely

(a) an algorithm which generates variable word length data scrambling

(b) a hierarchic system of key distribution (e.g. a regulated method for aging and then eliminating keys)

In place of a lengthy explanation, we begin by referring to FIG. 4 which illustrates the idea of variable word length text transformation. It will be clear that computerized scanning of the encrypted text will in this case have no prospect of providing any clue.

FIG. 5 shows a functional block diagram of the encryption/decryption hardware. In early implementations, a 16 bit shift register was used (block SR) with simple output to input connection. The encrypted output resulting from such an arrangement showed a certain periodicity if the clear text consisted of the binary representation of a single letter, for example the letter ‘a’ in unchanging repetition. This revealed the potential for a certain weakness of the method unless steps are taken to overcome this possible point of attack for a hacker. In present designs we use a 31-bit shift register as the basis for a pseudo random data generator wherein the periodicity is vastly (pattern recurrence only once every 2,14 billion different combinations) reduced. In addition, further measures are taken to begin each message with an undefined length of meaningless text. That text is not delivered in clear by the algorithm. For the user it constitutes simply a few seconds waiting time added to the setting up time. One method of achieving this will be explained in conjunction with FIGS. 3, 4 and 8.

Returning to the description of FIG. 5, parallel outputs from the shift register are connected to various logic elements under the heading LOGIC CONTROL. This comprises for example, a programmable counter, several flip-flops and bistables and various gates. Some of the logic control elements are also exposed to inputs of the logic levels of the real data, both outgoing or incoming. These data are applied with a delay of one full clock pulse duration. This is done in the squares named ‘bit delay’. The encrypted text on line l₂ is derived from an OR gate into which alternately pass bit elements from the real data and from the random data generator RD, respectively a, by real data modified, output from said generator. Encrypted data received are descrambled by action of the Logic Control group, in a single AND gate.

FIGS. 6 and 7 explain how it is possible to have 8-10 simultaneously valid keys and how they are weighted in a number aging process. FIG. 8 shows a functional block diagram of an LSI chip such as would be capable of carrying out data encryption at a high clock rate suitable for any communication network and would provide added security over and above the basic scheme of FIG. 5.

### BRIEF DESCRIPTION OF THE DRAWINGS

FIG. 1 is a representation of two personal computers using a fixed secret key consistent with the present invention.

FIG. 2 is a representation of another embodiment of how a key is used between a plurality of users and/or computers consistent with the present invention.

FIG. 3 is a diagram, partly in schematic, of an automated connection service for sending confidential messages consistent with the present invention.

FIG. 4 is a representation of an encrypted message consistent with the present invention.

FIG. 5 is a block diagram of encryption/decryption hardware consistent with the present invention.

FIG. 6 is a representation of an embodiment of a national key generator center consistent with the present invention.

FIG. 7 is a table illustrating the position changes of numbers that are classified by age consistent with the present invention.

FIG. 8 is a block diagram of an embodiment of a chip used in conjunction with the present invention.

FIG. 9 is a representation of the relationship between a plurality of client computers in a local region and an internet secure server in the same region with another distant server station.

FIG. 10 is a representation of the relationship between a secure server station with a local telephone exchange network.

### DETAILED DISCUSSION OF THE PREFERRED EMBODIMENTS

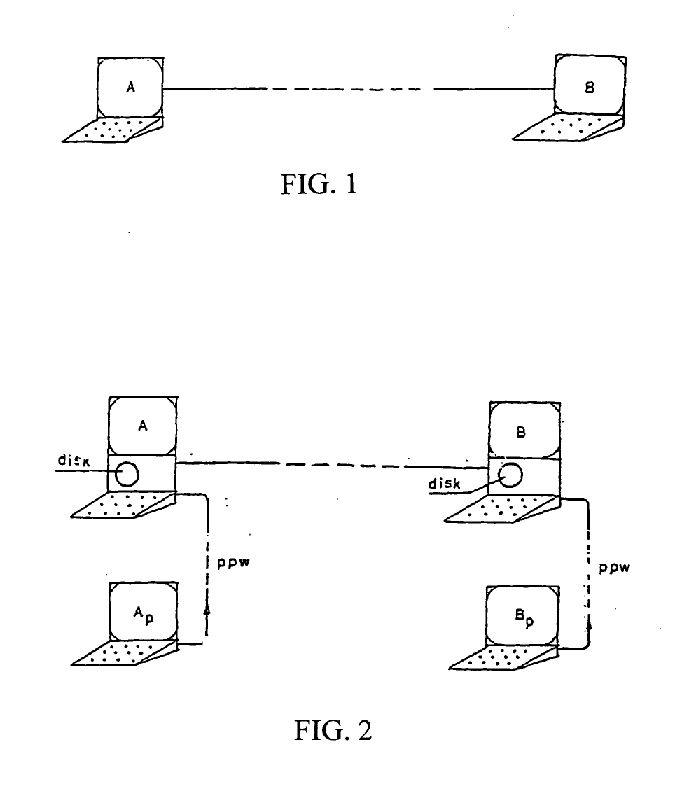

FIG. 1 shows two personal computers or communication work stations using a fixed secret key, or using a program permitting one of the stations to utilize the encryption key of the other.

FIG. 2 illustrates a situation where the official key employed within an organization is not normally used for the actual encryption/decryption of data. If, for example, station A represents the word processor in a secretarial pool of one company, and station B the processor office in another company, and the message sender has a small computer in his office Aₚ wishing to send a confidential message to a particular person having a computer Bₚ, then the procedure would be as follows:

(a) The secretary at A will type into the word processor A a statement from Aₚ in clear language and put it on disk.

(b) Next, the secretary agrees with Aₚ to display on the window of Aₚ the text as written for approval or amendments.

(c) When approved, Aₚ will contact the secretary at A over the phone to prepare internet connection with the communication of office at B.

(d) When communication is established, the secretary rings Aₚ to report ‘ready’.

(e) The executive at Aₚ now types his private password ppw into his keyboard thereby transmitting it to work station A where the instruction code tells the computer to deduct (or add) the pass number, or a multiple thereof, from the encryption key of the organization.

(f) Once this is done, a green light informs the secretary that the clear text derived from the disk is to be moved through the encryption algorithm and out into the Internet.

(g) The encrypted message is taken on disk at computer unit B. It cannot be read by staff.

(h) When executive Bₚ returns to his office, he will find a light signal indicating that he has a personal message. Accordingly, he will enter the agreed password ppw on his computer keyboard together with the instruction of deducting it from the common general key. After that, the decrypted message will appear on the screen Bₚ.

It would be technically possible to provide the managing chief in each company with an automatic printout of all personal messages, to enforce the sharing of confidential information.

Since the encryption system here expounded is not primarily determined by mathematical conversions, and therefore all numbers are equally suitable, it would suffice if the executives concerned are told that they must have a six-digit ppw. Knowledge of agreed passwords may therefore be limited to the parties themselves.

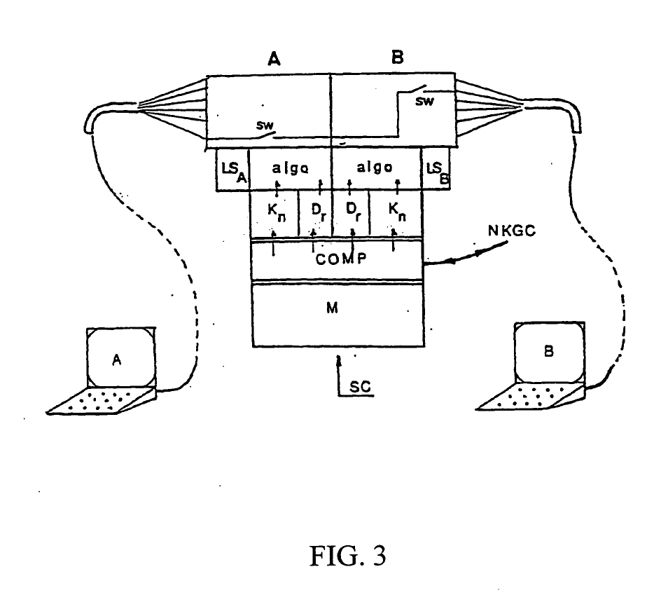

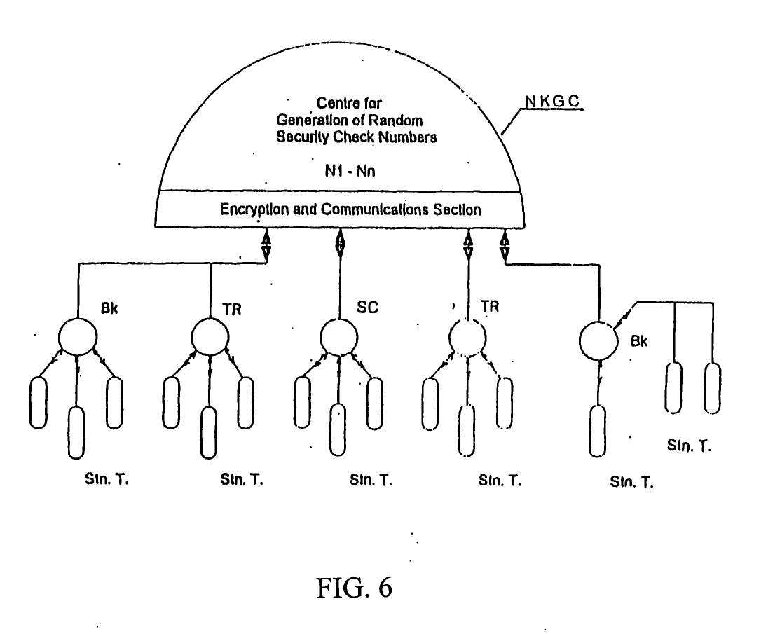

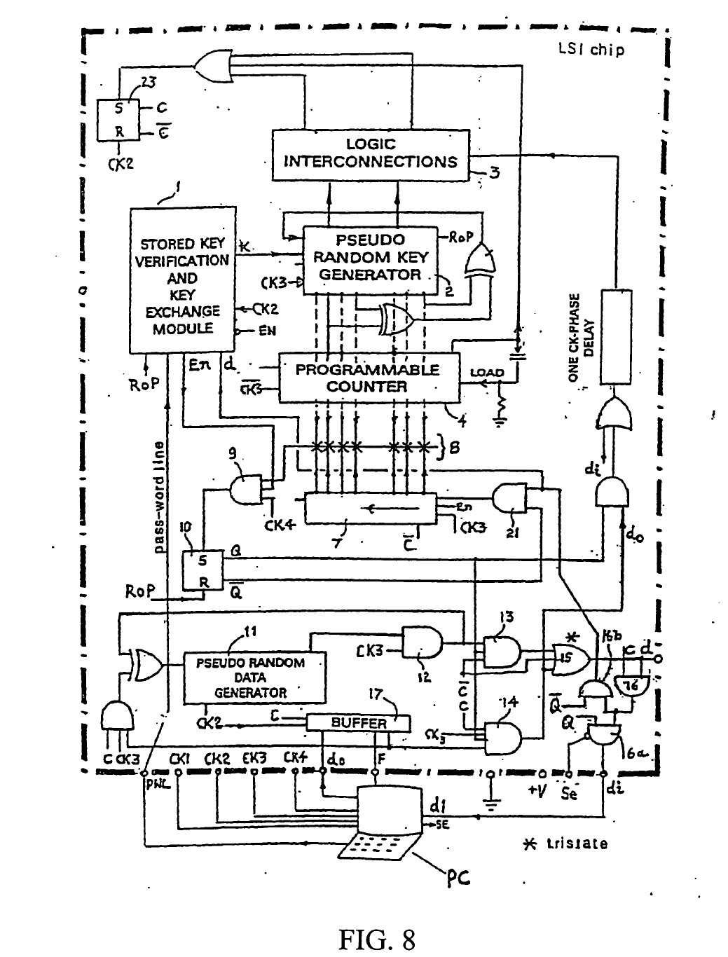

FIG. 3 shows the structure of a service center SC for almost fully automatic connection service to clients wishing to send messages required to remain confidential. FIG. 3 shows again a workstation A in one locality and another workstation in a remote locality but using the same equipment. The central server station consists of two sections (A & B). These sections comprise channel switching section sw, switch control sections LS_{A} or LS_{B}; two algorithmic sections virtually identically with those shown for example in FIG. 8; In each section is also a key register for storing a key Kₙ and a random text data holding register Dᵣ. Below is a computing section COMP, and below that a memory of past transactions, M. The computer unit COMP has a preferably direct link with a National Key Generator Center NKGC. Where a direct link is not available, a switched connection with NKGC will do because no clear data are passed through this link (see also FIG. 6). The process prior to A sending a confidential message to B, can be reported in ten steps.

(1) station A dials the local Service Center (SC) and immediately thereafter dials also the number of the desired recipient B.

(2) Station A gets indication that connection is made.

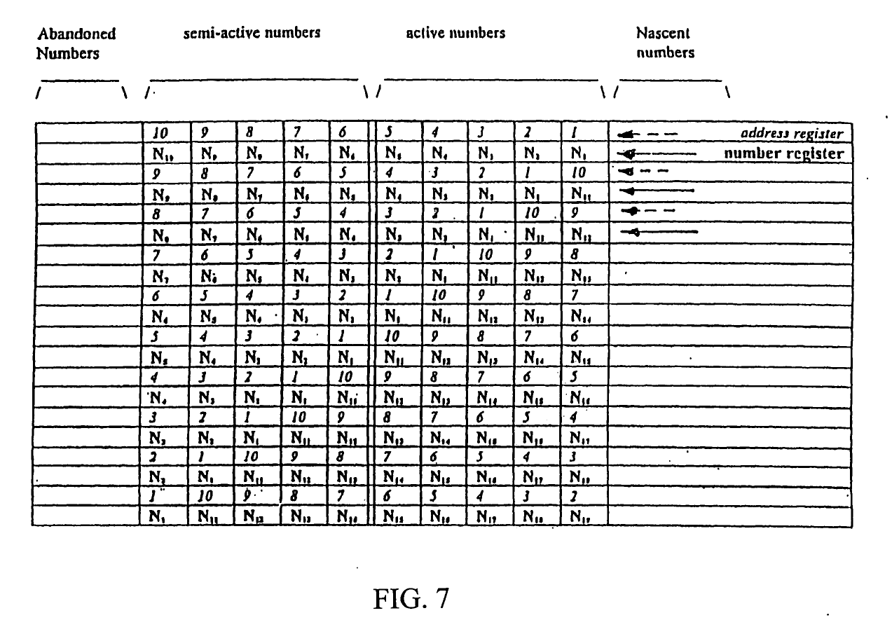

(3) prompted by (2), section A receives from station A the address code for identifying the key held at present by station A (see address reg., FIG. 7).

(4) section B of SC calls station B.

(5) Station B responds by sending its address in clear.

(6) using the two address numbers from A and B, the SC looks up from a memory table similar to that of FIG. 7 at the tine valid secret key numbers. Section A of SC extracts the key nr. for station A, inserts it into the algorithm (algo) thereby encrypting K_{A} by K_{A} and sends it to station A for verification. Section B of SC proceeds likewise with station B (the table is stored in section COMP, and is periodically updated from the national key generator center, see FIG. 6).

(7) A and B receive the encrypted keys K_{A}′ and K_{B}′ respectively, decrypt them with their respective K_{A} and K_{B} keys, and if any station cannot verify, it sends to the respective section of SC a repeat request. If this also fails, a ‘failed’ signal in clear goes to both stations.

(8) With both comparisons correct, the SC proceeds to obtain from its COMP section an alternative key number K_{C} which section A encrypts with K_{A}, and section B encrypts with K_{B}, and sends these numbers to stations A and B respectively where they are decrypted and entered into their key registers, substituting their earlier keys.

(9) Stations A and B send out K_{C} to the respective sections of SC where they are compared to test equality.

at this point both stations would be ready to communicate. The time lapse so far (after the initial dialing by station A) would be less than 4 seconds. To improve security further a further step is adding a few seconds to the setting up procedure:

(10) The Computer Resource Unit COMP supplies to the operative sections a random number called Dᵣ where it is entered into a register connected for generating through re-circulation a fairly large pseudo random number. This number; is continually passed through the algo sections of SC, and the output is sent to stations A and B where they are decrypted and continually passed through a comparator register being only a few bits (5-12) long. Parallel outputs from this register are continually compared with a similar number of selected parallel bit outputs from the larger, in the opposite sense rotating, key register. Whenever all the bit positions of the static bit comparator are at the strobing moment equal, a pulse is released both in the stations A and B and in the Server Center SC internally which Stops the Dᵣ bit generator and establishes in the switching sections sw a direct connection between A and B.

It should be noted that the true tine distance in terms of real data clock pulses could not be determined by a hacker and therefore no conclusion be drawn as to the number structure of the initial key in the key register of the algorithm. This is because the variable word length encryption applies also to the Dᵣ data stream transmission.

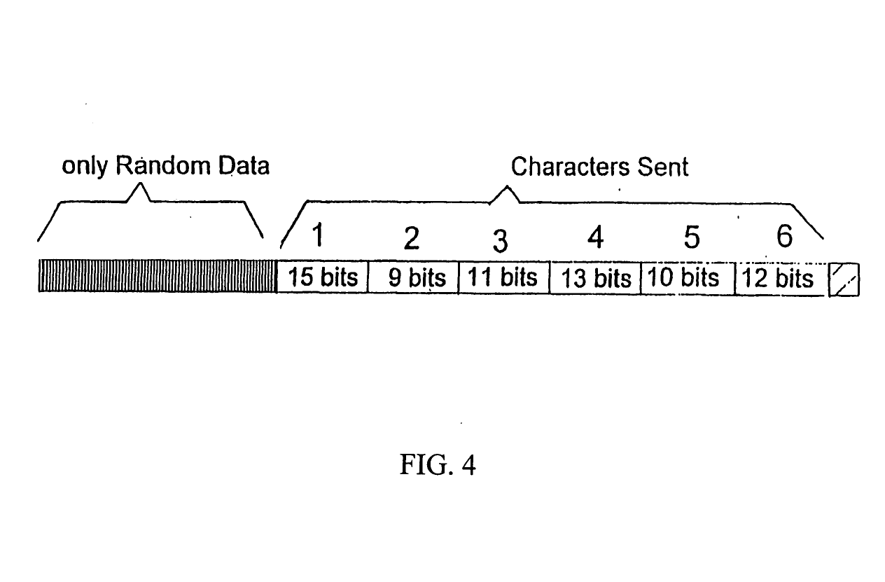

FIG. 4 illustrates the nature of an encrypted message consisting as it does of an initial phase of random data the length of which cannot be externally detected, and a transmission phase consisting of a quasi-random mixture of real data bits and random bits all in a single undivided string of bits giving no clue where one word begins or ends. There is thus no reference points against which an analyst might be able to study the bit sequences.

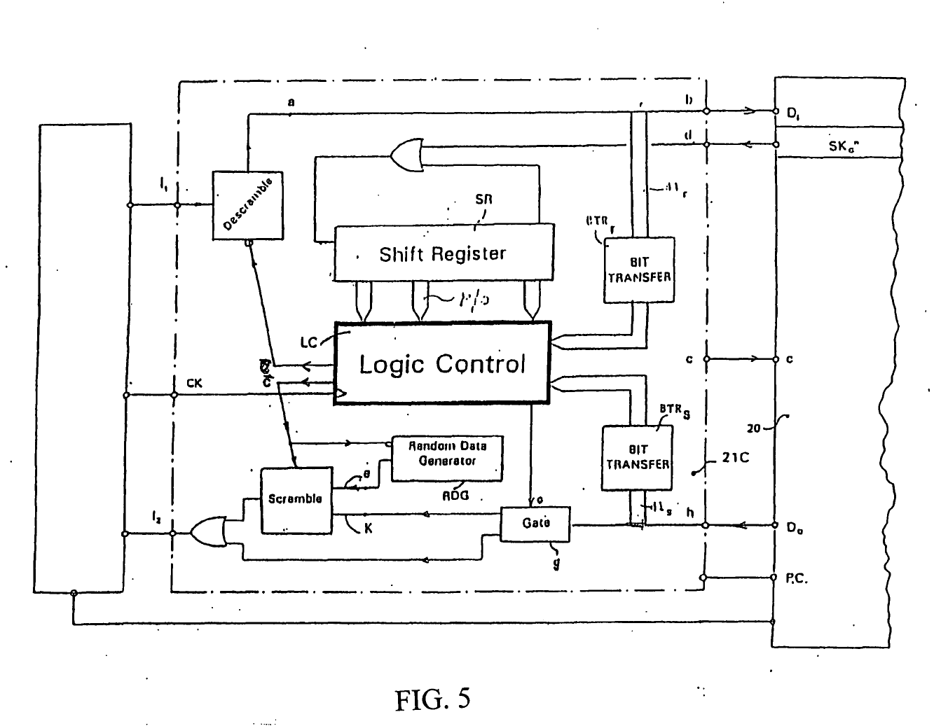

FIG. 5 has already been adequately dealt with on page 2.

FIG. 6 explains the role of the NKGC (national key generator center). In that center the Kₙ numbers with their address allocations, and also the Dᵣ numbers are generated and the protocol for the transfer of these numbers to head offices of various kind is observed. The management of the center would be limited to determining the optimum rate at which updates for new numbers should be made. This would be set responsive to the performance of the system as a whole as reported by supervisors. Performance reports from head offices such as Bk (banks) or TR (transport organizations) or SC's (service centers for confidential communications) would be studied by supervisors and appropriate responses formulated. Management would have no access to actual key numbers. When a station malfunctions, its encryption module is detached and sent to the factory, and replaced by a factory-new one.

It is here suggested that both system wise and with respect to the encryption module IC, the here explained confidential message system may be used. Also in bank transaction as also in remotely issued travel passes and routing instructions.

FIG. 7. This table surveys the position changes of a number which ranges from a nascent phase to an active, semi-active, and finally abandoned phase. The numbers are classified in terms of age. The active number range comprises in this example five aging positions, and so does the semi-active range of numbers. If each column segment represents the tine span of, say, one week, it would take ten weeks for a number to travel from the nascent region through the active and semi-active region, in order to exit into the for normal use in accessible abandoned region.

Once an address is allocated to a number, the two numbers remain associated during their migration through said regions.

Both active and semi-active numbers are valid numbers, and are therefore accepted by terminals and server stations for commencing a communication.

However, either right at the beginning or after completion of the communication event, an older active number is substituted by a younger one, or any semi-active number is substituted by any number from the active region. If an Internet station, or an IC card-through non-usage over a longer period of time-has in its encryption algorithm a number which at the tine of re-use belongs to an abandoned number, it would be necessary to make contact with certain supervisory organs which have at their disposal access to a central register which keeps a record of numbers in the past. Such organs would be allowed to also make additional checks before they override the absence of a valid key number and bring the station or card up to date again.

FIG. 8. This shows an example for the LSI chip circuit block diagram. A chip of this type would be needed in an extension card for insertion in one of the slots for extension functions, such as are common in personal computers. The following are the main features of the chip:

The four clock. phases needed to operate the circuit may be either on chip generated or supplied by the Computer (as FIG. 8 indicates). The chip would also be used in the Service Center SC. There is a STORED KEY VERIFICATION AND KEY EXCHANGE MODULE (1). This group has four input lines (ROP, CK2, En and password) and two output lines En & K. In connection with Internet operation, there may be at least one more input from outside the chip, when namely the output EN has to be delayed because of delays in getting a connection completed or for whatever other reason. When the electric level at EN changes this indicates that verification and key exchange are satisfactorily completed and, with everything else being ready the next phase can begin. The ROP input to module 1 resets all internal bistables and occurs when power is switched on or shortly afterwards. The d-input is connected to the incoming signal line to enable the address reference for the encryption key held, to be read out. This last mentioned detail is not shown worked out in FIG. 8.

In practice, the circuit must satisfy the condition that external communication of keys must take place only in the encrypted form. The input CK2 provides the proper clock phase for the key exchange functions. The out-put K transfers to block 2 the new key before commencing the encryption and decryption functions. All encrypted incoming line signals are decrypted by gate 16.

The pseudo random key generator rotates the shift register 2 with every CK3 clock pulse. The programmable counter 4 is advanced with every CK3 clock pulse. The bistable 23 is reset with every CK2 clock pulse. The programmable counter, after producing a carry output, is loaded with the parallel output from the key generator at the time, that is between CK3 and the following CK2. The incoming or outgoing real data bits also have an effect on the constellation of the logic interconnections, block 3 in that the consecutive data bits are fed with the delay of one complete clock cycle to block 3. From this arrangement, it follows that discovery of the clear text is not possible without the prior knowledge of the clear text, making discovery superfluous. Text generated in the PC is connected to a buffer register 17 or perhaps two such registers, via the terminal dₒ. The buffer fills until a signal F (full) is fed back to the computer. As the buffer clears due to passing on data to gate 14, the buffer register is filled up again from an overflow register in the computer itself.

The job of the pseudo random data generator, block 11, is to provide meaningless data bits to be fed to outlet ‘d’ via the gates 12 and 13 when c is high. The gate 14 admits data from the buffer 17 only when c is high. As the bistable outputs c and c are dependent on the rest of the algorithm, a quasi-random mixture of real and fake data is produced at the d output when in the sending phase. When in the receiving phase, the scrambled mixture of real and random data bits is descrambled by gate 16. The remaining real data in the gate 16 output are channeled in the very beginning before the actual message transmission to gate 21 and to the d input to block 1 during the initial key checking c and exchanging phase. The output from 21 feeds into a short shift register 7 which has parallel outputs for each of the bits it holds. These are applied to a static comparator 8 and compared bit by bit with an equal number of outputs from the register of block 2. As both the registers are shifted on the rising edge of CK3 but in opposite directions this has the effect of scanning and testing the registers as to the chance of hitting a seven bit (or 5-bit, etc.) combination where all the input bit comparisons are successful causing an output pulse by the strobing clock CK4 AND gate 9 to trigger bistable 10. As the gate of 16b is enabled by Q, with the disappearance of this high level the flow of encrypted nonsense data stops. A very similar arrangement in the Service Center SC also causes the flow of these data to stop and to connect the station A (FIG. 3) with station B directly via switch elements sw. From now on, encrypted data are meaningful text from A to B. Station B will from that moment on, channel data received at d (FIG. 8) through gates 16 and 16a to the output interface dᵢ on the PCB whose adge contactors are plugged into the appropriate sockets inside the PC. When the workstation PC sends, an output SE is generated which disables the gate 16a. The computer can also generate a signal along chip input pwl (password line) to modify the encryption key as explained in connection with the comment on FIG. 2.

Finally, the question should be addressed whether the present encryption system permits the communicating parties to engage in a dialogue. The answer is yes, messages may be sent in both directions with or without pause and there is no limit to the length of the message or of the dialogue.

Because of the nature of the encryption method which defies any form of systematic factoring of the encrypted text, it is unlikely that a freelance hacker can be a threat to the described system in spite of the fact that the interchanges between the Client Computer (CC) and the Server Station (SSt) contain one element, the address information, in the clear.

In a slightly better position are the expert engineers of the server stations which may have an insight into the precise moment when within the encrypted data flow various addresses are offered. In a very general way one may admit the possibility of a problem that may then arise. An alternative scheme would permit also the address code to be sent only in the encrypted form.

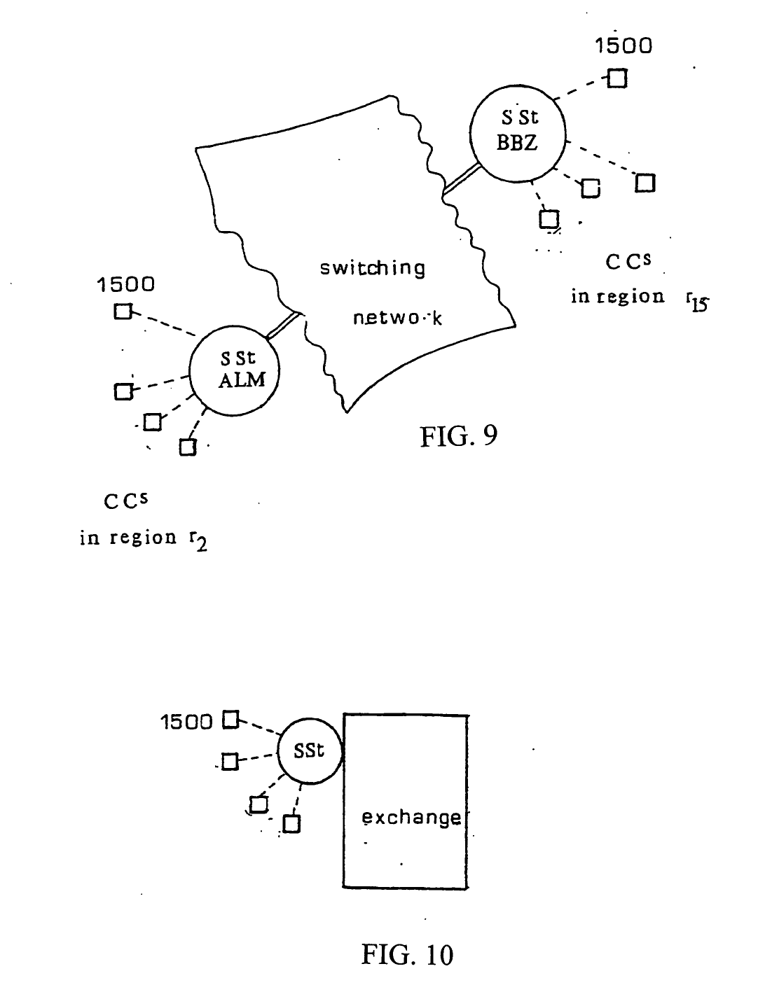

According to our proposal, the Client Computers of a local region would have a special relationship with the Internet Secure Server station of that same region (SSt). The Client Computer (CC, FIG. 9) would, when contacting the Server, send to it its ID number. This number serves as an address in the Server station's memory bank which would contain the very same data as the Client station, namely a chip serial nr. and/or the date of inauguration of the client chip (from an unalterable ROM). The last entered encryption Key nr. The last entered Preamble Delay nr. .Dᵣ and in place of a revolving address code, an annual sequential entry serial nr.

Based on this information, the calling station may immediately begin with sending its own data in encrypted form which the receiving server station would place into a comparator register, and if all these data are correct, will automatically issue a new key number and preamble random delay number and the next sequential nr., in encrypted form using the old key, and the corresponding decrypted clear data are then placed into the memory of the Client Computer station. Its operator is, requested to dial the distant station to which message material is to be sent. The dial number would pass through the encryption algorithm and therefore does not allow a third party to know which company or person will be connected. The first part of the dial code will call up the distant Server station (for example BBZ) and the number part will call up the particular CC, say 1500. When the latter responds, it sends its own ID number to the distant local Server station, and a similar comparison process as described above, is initiated. If this verifies that the correct CC station has been contacted, the new key (Kₙ₂) given to the calling station is now also given to the called station. After this is verified, this is made known to the calling station, and a display invites its operator to proceed sending the intended material (text, drawings, voiced comment, etc).

The just described alternative logistics for a variable word length data transmission system, would blend well into telephone and Internet based communication infrastructures.

It is feasible that just one further step in this direction could be made by integrating the envisaged function of secure server stations with the location of telephone branch exchanges (as indicated in FIG. 10), This would be economical in installation costs, and could work fully automatically in the environment of an automatic switching system. This does not exclude the computerized electronic equipment being housed in a separate reinforced building. It would suffice to have that building in close vicinity to the said telephone exchange station.

1. An encryption and fully automatic key renewal system for confidential email communication comprising at least two email stations adapted for transmitting data linked to a communication system; the encryption and automatic key renewal system comprising:
a key generation center for the generation of a plurality of random keys for the use of said at least two email stations;
means for the periodic renewal of at least one of said plurality of random keys used by said at least two email stations; and
local server stations which store and update at least one of said plurality of random keys generated in said key generation center; characterized in that
said local server stations are adapted to store at least one of said plurality of random keys in a look-up table, each of said keys having an address code and data indicative of the age of each of said keys, and to classify the age relative to the age of other keys in said plurality of random keys in use at any given time; and
said server station including means adapted to issue, prior to each data transmission from said at least two email stations, a random key to the sending email station, said key to be used by said station for scrambling or encrypting the data to be transmitted;
wherein said look-up table stores a fixed number of said random keys conjointly with their respective address code in a shift register memory structure wherein said fixed number of random keys and said addresses can be moved at quasi randomly arranged times from a younger to an older position, said youngest position serving as an entrance point for a key supplied by said key generation center, and the oldest position designating an inactive and reserved position outside said fixed number of keys.

2. The encryption and fully automatic key renewal system for confidential email communication as in claim 1, wherein the said at least two email stations have means for encrypting and decrypting data including said random keys comprising means for executing a key replacement routine which accepts a key only on the basis of a successful completion of the replacement routine, the said routine being implemented prior to the transmission of a key from said local server station to said email stations.

3. An encryption and automatic key renewal system for confidential email as in claim 1, comprising means for recognizing the legitimacy of a server station by a calling email station, comprising
(a) means for sending to the server station the address code associated with the email station's encrypting key;
(b) means for using the address to obtain the calling station's encryption key;
(c) the server station comprising equipment to encrypt the key encryption number with itself;
(d) the server station also comprising means to send the encrypted key to the email station;
(e) the email station comprising means for decrypting the received key, using its own key and placing the result into a comparator register, and means for determining if the compared numbers are equal for informing the server station accordingly.

4. An encryption and automatic key renewal system for confidential email as in claim 3, wherein in the case that the compared numbers are equal the server station is programmed to obtain from its storage means an alternative key number from the currently stored key numbers, and to encrypt that new number with the key of the calling station, and wherein the latter is programmed upon receipt of the encrypted new key to decrypt said number and to place it into its key register in substitution of the number it had before.

5. An encryption and automatic key renewal system for confidential email as in claim 3, wherein the server station is operable to act as an interface for connecting a calling station to a requested receiving station, and wherein the server station consists of a computer section and a twin structure which is equipped with two sets of encryption algorithm, two sets of switching controls, and two sets of buffer memories for holding key number, address codes and other relevant flags as supplied by the computer section.

6. An encryption and automatic key renewal system for confidential email as in claim 5, wherein the said server station also contains a pseudo-random generator register in order to generate a mixture of real and random data inputs of equal length simultaneously transmitted and encrypted by the said alternative key number to the communicating stations in order thereby to shift the starting conditions in the algorithms of the email units for the real text to an undetectable point.

7. An encryption and automatic key renewal system for confidential email as in claim 5, wherein the algorithms used for the encrypting process produce word-bit configurations consisting of more than 8 bits and less than 16 bits per word transmitted, and the bit number per word is continually changing.

8. An encryption and automatic key renewal system for confidential email as in claim 6, wherein the precise point in time for switching the communicating stations is functionally defined by comparing the data flow in a shift register with that of a short shift register whereby the data shift is prompted by the same clock phase but occurs in opposite directions.

9. An encryption and automatic key renewal system for confidential email as in claim 1, comprising:
(a) a stored key verification and key exchange module,
(b) a pseudo random key generator,
(c) a system of logic circuit elements and interconnections between them
(d) a programmable counter
(e) an open-ended shift register with parallel bit outputs
(f) a pseudo-random data generator for supplying surplus data bits
(g) a one clock-pulse delay circuit which delays real data bits incoming and outgoing in affecting the state machine or algorithm status, and
(h) a serial buffer system for accepting work station data and to pass it to the algorithm in accordance with the instant state of the algorithm.

10. An encryption and automatic renewal system for confidential email as in claim 9, wherein the said module also contains mathematical processing means for adding or deducting a password from a key in a key register of said module.

11. An encryption and automatic renewal system as claimed in claim 1, wherein said data to be encrypted is encrypted using a variable word length encryption system, wherein the data output from the encryption system comprises random data bits and real data bits, said real data bits being transmitted at a randomly varying rate, according to the key being used by said email station.

12. In an encryption and fully automatic key renewal system, a key replacement routine comprises the steps of:
in an automatic server station: receiving from a calling station a stored encryption key access address in clear text and in encrypted form the email number of the party to be called,
based on said access address, identifying the encryption key which had been allocated to the calling station for its preceding confidential email communication,
based on said identified key, the automatic server station encrypting the key by itself and adding a quasi random check number in encrypted form, and sending both to the calling station,
the calling station comparing the decrypted received key with the one stored, and, if not identical, providing an indication thereof,
the email station sending a decrypted check number to the server;
the automatic server station receiving from the email station the decrypted check number and comparing it with the check number used before encrypting it, and, if not the same, will not proceed, and if the same, will decrypt the access number of the called station, and the automatic server executing the call repeating the verification steps carried out with the calling station.

13. An encryption and automatic encryption key renewal system for confidential email communication, comprising at least one email station linked to the communication system; said system comprising a pseudo-random data generator; characterized by a key generation system and an encryption circuit, said key generation system automatically providing said email station with a new encryption key before each email communication, and wherein the output of said pseudo-random data generator is mixed with the bit levels of outputs of said encryption circuit and with clear bit levels of said input data, according to said key, so as to diffuse any pattern such as may be recognized in the expanded data words.

14. An encryption and automatic key renewal system as claimed in claim 13, wherein the operation of said encryption circuit is operable to be continually influenced and modified
(a) by the parallel bit outputs of a revolving encryption key register, and
(b) by the clear bits of the data inputted to the encryption circuit for encryption or outputted from the encryption circuit after decryption.

15. An encryption and automatic key renewal system for confidential email as claimed in claim 1, wherein the encryption process is determined by an algorithm embodied in a microelectronic chip and wherein this process is not rigidly predetermined but is operable to be continually influenced and modified
(a) by the parallel bit outputs of a revolving encryption key register, and
(b) by some but not all the clear bits of the data inputted to the said algorithm circuit for encryption or outputted from the said algorithm circuit after decryption.

16. An encryption and automatic key renewal system for confidential email as characterized in claim 14, wherein the functionality of the said microelectronic chip circuit is operable to be further influenced and modified
(c) by the configuration of a password entered by an operator at the sending and receiving stations in order to ensure that the transmitted text, picture or voice mail is faithfully reproduced only for those persons who are intended to know it.

17. An encryption and automatic key renewal system for confidential email as in claim 15, wherein the means for carrying out the encryption process includes a memory into which can be written only once when a specific email station is inaugurated and associated with a definite inauguration date, a definite serial number, and a definite name and a definite server station (SC) with a memory bank, and wherein the ID number of a client computer (CC) is held in memory by the local server station (SSt) at an address number which is numerically identical with said ID number.

18. An encryption and automatic key renewal system for confidential email as claimed in claim 13, wherein the encryption process is determined by an algorithm embodied in a microelectronic chip and wherein this process is not rigidly predetermined but is operable to be continually influenced and modified
(a) by the parallel bit outputs of a revolving encryption key register, and
(b) by some but not all the clear bits of the data inputted to the said algorithm circuit for encryption or outputted from the said algorithm circuit after decryption.

19. An encryption and automatic key renewal system for confidential email as claimed in claim 14, wherein the encryption process is determined by an algorithm embodied in a microelectronic chip and wherein this process is not rigidly predetermined but is operable to be continually influenced and modified
(a) by the parallel bit outputs of a revolving encryption key register, and
(b) by some but not all the clear bits of the data inputted to the said algorithm circuit for encryption or outputted from the said algorithm circuit after decryption.
